(19) United States
(12) Patent Application Publication
(10) Pub. No.: US 2020/0370659 A1
(43) Pub. Date: Nov. 26, 2020

(54) ROTARY VALVE

(71) Applicant: LB Bentley Limited, Gloucestershire (GB)

(72) Inventor: NOELLE SEARS, Stroud Gloucestershire (GB)

(21) Appl. No.: 16/960,364

(22) PCT Filed: Dec. 21, 2018
(86) PCT No.: PCT/GB2018/053742

§ 371 Date: Jul. 7, 2020

(30) Foreign Application Priority Data
Jan. 11, 2018 (GB) 1800428.3

(51) Int. Cl. F16K 3/08; F16K 3/316

(52) U.S. Cl. CPC F16K 3/08; F16K 3/316; F16K 3/3165

(57) ABSTRACT

A rotary valve (10), comprising a housing (12) defining a chamber (16), a valve member (22) located within the chamber (16) and engageable with a seating surface (18) to control fluid communication between a first port (20) and a second port (20), a drive shaft (28) controlling the angular position of the valve member (22), and an actuator (30) coupled to the drive shaft (28), wherein a roller bearing arrangement (34) is provided between a surface of the valve member (22) and a surface of the housing defining the chamber (16).

This invention relates to a rotary valve, and in particular to a rotary gate valve.

Rotary gate valves are in widespread use in a number of applications, controlling the flow of a fluid along a passageway. One form of gate valve comprises a rotary valve member located within a housing. The valve member carries a pair of gate buttons which, in use, bear against a seating surface of the housing. When the valve member occupies a closed position, the gate buttons overlie ports provided in the housing, preventing the flow of a fluid between the ports and a chamber within which the valve member is located. Movement of the valve member away from this position results in the gate buttons no longer closing the ports, fluid flow between the ports via the chamber then being permitted.

The valve member includes or is connected to a drive shaft which protrudes from the housing. An actuator is attached to the drive shaft, the actuator being accessible from the exterior of the housing, and may be used to drive the drive shaft, and hence the valve member, for rotary or angular movement, thereby allowing control over the operation of the valve.

The valve may be used in applications in which the fluid controlled using the valve is under high pressure. In such applications, the pressure of the fluid can result in the valve member experiencing relatively large loads urging parts thereof into engagement with surfaces defining part of the chamber. As a result, a significant resistance to rotation or angular movement of the valve member may be experienced. Furthermore, where the valve is used in high pressure environments such as subsea environments, then the hyperbaric pressure exerted on the actuator may result in a load being applied to the valve member in a direction resulting in the gate buttons being forced very firmly against the seating surface. This, likewise, may result in significant resistance to rotation of the valve member being experienced. Also, there is a risk of the seating surface and/or the gate buttons being damaged as a result of the loads experienced, over time, and this may lead to premature failure of the valve, or in premature servicing or maintenance thereof being required.

In order to keep the size of the valve to a minimum, and avoid unnecessary material costs, there is a desire for the drive shaft to be of small diameter. However, where significant resistances to rotation are experienced, there may be a concern that a drive shaft of relatively small diameter may be incapable of transmitting a torque of sufficient magnitude to cause rotation of the valve member against such resistances to rotation.

It is an object of the invention to provide a rotary valve in which at least some of the disadvantages associated with known valve designs are overcome or are of reduced impact.

According to the present invention there is provided a rotary valve comprising a housing defining a chamber, a valve member located within the chamber and engageable with a seating surface to control fluid communication between a first port and a second port, a drive shaft controlling the angular position of the valve member, and an actuator coupled to the drive shaft, wherein a bearing arrangement is provided between a surface of the valve member and a surface of the housing defining the chamber.

The bearing arrangement may comprise a roller bearing arrangement. However, this need not always be the case and other forms of bearing may be used. By way of example, the bearing arrangement may comprise a static bearing element, for example in the form of a washer or the like of a suitable material. The static bearing element may be of, for example, PTFE or PEEK, or another suitable low friction material with a good wear resistance.

It will be appreciated that the provision of the bearing arrangement is advantageous in that loads applied to the valve member as a result of the use of the valve in controlling high pressure fluids can be borne by the bearing arrangement without resulting in the formation of a significant resistance to rotary or angular movement of the valve member.

The bearing arrangement is preferably located between a surface of the valve member opposing the face thereof that, in use, bears against the seating surface and the corresponding surface of the chamber. Alternatively, or additionally, the bearing arrangement may bear against a side of the valve member. Where the bearing arrangement is of the static form and bears against both the face of the valve member opposing that which bears against the seating surface and against the side of the valve member, the bearing arrangement may comprise a bearing member of cup shaped or conical form.

The drive shaft may be integrally formed with the valve member. Alternatively, it may be a separate component coupled to the valve member.

A seal arrangement may be provided between the drive shaft and the housing, the seal arrangement restricting the escape of fluids from the chamber, in use.

The coupling of the actuator to the drive shaft is preferably of a form allowing limited relative axial movement therebetween. The use of a coupling of this type is advantageous in that loads arising from the pressure acting upon the actuator need not be transmitted to the drive shaft and valve member. Resistance to rotation of the valve member as a result of the application of such pressures is thus reduced or avoided. Furthermore, damage to parts of the valve arising from the application of such pressures can be reduced or avoided.

The valve member is preferably provided with a stop projection engageable with the seating surface to restrict movement of the valve member relative to the seating surface.

Preferably, the valve member is arranged to carry at least one gate button engageable with the seating surface. The gate button is preferably moveable relative to the valve member through a first distance. The maximum spacing of the stop projection from the seating surface is preferably smaller than the first distance.

According to another aspect of the invention there is provided a rotary valve comprising a housing defining a chamber, a valve member located within the chamber and engageable with a seating surface to control fluid communication between a first port and a second port, a drive shaft controlling the angular position of the valve member, and an actuator coupled to the drive shaft, wherein the coupling of the actuator to the drive shaft is of a form allowing limited relative axial movement therebetween.

By way of example, the coupling between the actuator and the drive shaft may be of limited telescoping form. Conveniently, the drive shaft includes an end part of non-circular cross-sectional shape received within a recess of a similar non-circular cross-sectional shape provided in the actuator such that relative angular movement between the actuator and the drive shaft is restricted, whilst relative axial movement therebetween is permitted. Preferably, the cross-sectional shapes of the interengaging parts of the drive shaft and the actuator are chosen to allow the actuator to be fitted to the drive shaft in a single relative angular orientation.

According to yet another aspect of the invention there is provided a rotary valve comprising a housing defining a chamber, a valve member located within the chamber and engageable with a seating surface to control fluid communication between a first port and a second port, a drive shaft controlling the angular position of the valve member, and an actuator coupled to the drive shaft, wherein the valve member is provided with a stop projection engageable with the seating surface to restrict movement of the valve member relative to the seating surface. The valve member is preferably arranged to carry at least one gate button engageable with the seating surface. The gate button is preferably moveable relative to the valve member through a first distance. The maximum spacing of the stop projection from the seating surface is preferably small than the first distance.

The invention will further be described, by way of example, with reference to the accompanying drawings, in which:

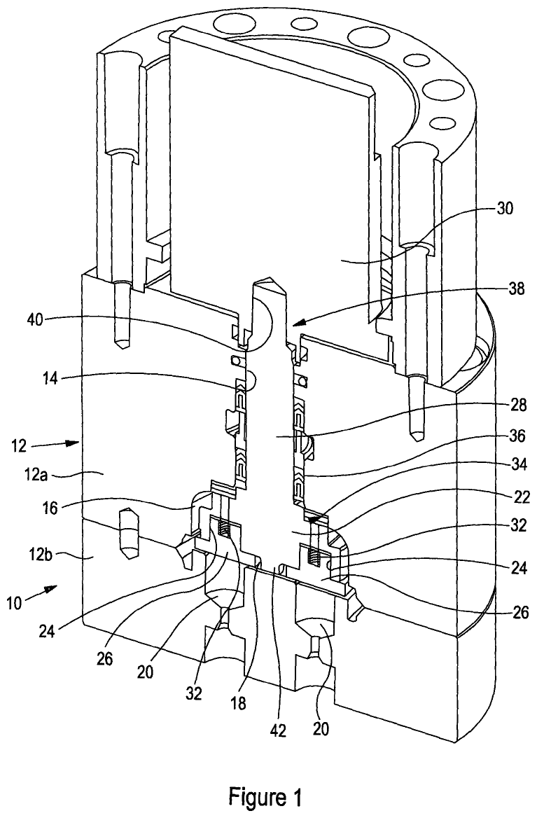

FIG. 1 is a cross-sectional view illustrating a rotary valve in accordance with an embodiment of the invention; and

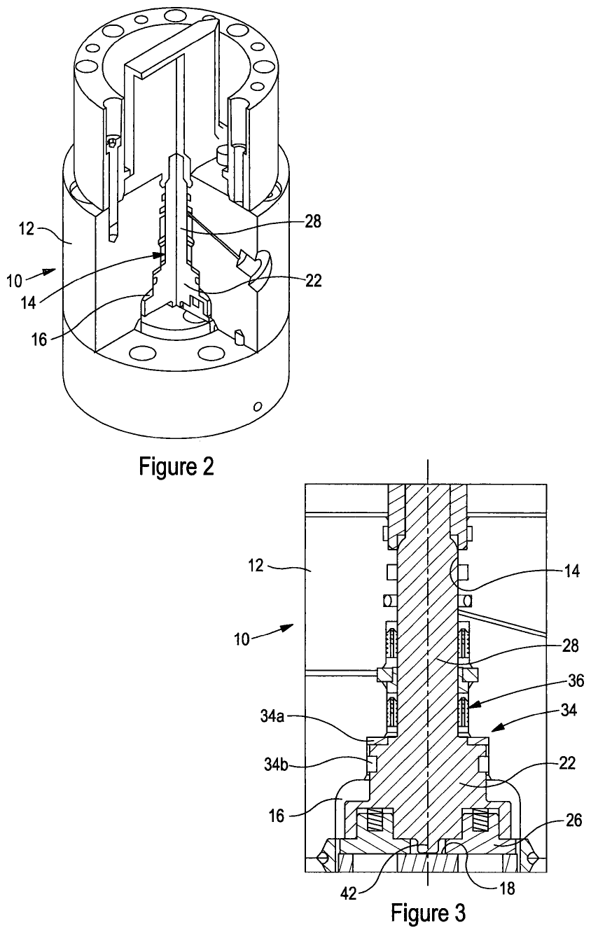

FIGS. 2 and 3 illustrate an alternative embodiment of the invention.

Referring firstly to FIG. 1 of the accompanying drawings, a rotary gate valve 10 is illustrated. The valve 10 comprises a valve housing 12 of multipart form. The housing 12 includes a central section 12a through which a bore 14 extends. The bore 14 includes an enlarged diameter section which, together with a face 18 of a second section 12b of the housing 12, defines a chamber 16. The face 18 defines a seating surface. The section 12b is formed with ports 20 which open into the chamber 16.

Located within the chamber 16 is a valve member 22. The valve member 22 is shaped to define pockets 24 within which respective gate buttons 26 are located. The buttons 26 engage the seating surface 18 and are positioned so as to the able to close the ports 20 in one angular orientation of the valve member 22.

The valve member 22 includes an integral drive shaft 28 which extends along the bore 14 and projects from the housing 12. An actuator member 30 is coupled to the projecting end of the drive shaft 28. In use, rotation of the member 30 is transmitted by the drive shaft 28 to the valve member 22. It will be appreciated, therefore, that the valve member 22 may be driven between a closed position (as shown in FIG. 1) in which the gate buttons 26 close the ports 20, and an open position in which the ports 20 are not closed by the buttons 26. When in the closed position, fluid flow between the ports 20 is resisted. Once in an open position, fluid is able to flow between the ports 20 via the chamber 16.

As illustrated, springs 32 are provided between the valve member 22 and the buttons 26 to bias the buttons 26 into engagement with the seating surface 18.

A roller bearing arrangement 34 is provided between the face of the valve member 22 remote from the seating surface 18, ie the surface of the valve member 22 opposite that bearing against the seating surface 18, and the adjacent face of the housing section 12a. The bearing arrangement 34 serves to limit axial movement of the valve member 22 away from the seating surface 18, supporting the valve member 22 for rotation within the chamber 16. Whilst not illustrated, if desired, the bearing arrangement could be located, alternatively or additionally, between a side wall of the valve member 22 and the corresponding surface of the chamber 16, thereby supporting the valve member 22 against lateral movement or laterally directed loads.

A seal arrangement 36 is provided around the drive shaft 28, between the drive shaft 28 and the surface defining the bore 14, the seal arrangement 36 restricting fluid flow along the bore 14 and so restricting the escape of fluid from the chamber 16 along the bore 14, in use.

The actuator member 30 is coupled to the drive shaft 28 by a coupling 38 designed to allow the transmission of rotary motion between the actuator member 30 and the drive shaft 28, whilst allowing limited relative axial movement between the drive shaft 28 and the actuator member 30. In the arrangement shown, an end part of the drive shaft 28 is shaped to be of non-circular cross-sectional shape. The actuator member 30 is formed with a recess 40 of cross-sectional shape substantially matching that of the end part of the drive shaft 28, the end part of the drive shaft 28 being received within the recess 40. The interengagement between the drive shaft 28 and the actuator member 30 is thus such that rotation or angular movement of the actuator member 30 is transmitted to the drive shaft 28, and hence to the valve member 22, to cause rotation or angular movement thereof to control the operation of the valve 10. The fit of the end part of the drive shaft 28 within the recess 40 is such that the drive shaft 28 is able to undergo limited axial telescoping movement relative to the actuator member 30.

The cross-sectional shape of the end part of the drive shaft 28, and the corresponding shape of the recess 40, are preferably chosen such that the actuator member 30 can only be fitted to the drive shaft 28 in a single relative angular orientation. The risk of incorrect assembly of the valve is thus reduced.

The face of the valve member 22 facing towards the seating surface 18 is shaped to include a central stop projection 42 which is engageable with the seating surface 18 to restrict the distance through which the valve member 22 can be moved towards the seating surface 18. The size of the projection 42 is preferably chosen such that, when the projection 42 engages the seating surface 18, further telescopic movement of the buttons 26 into the pockets 24 is still permitted. In other words, where the gate buttons 26 are able to move relative to the valve member 22 through a first distance, the maximum spacing of the stop projections 42 from the seating surface 18 is less than the first distance.

In use, in the position shown the valve is closed. In this position, the gate buttons 26 are held in an angular position by the valve member 22 in which they cover and close the ports 20 and so fluid flow between the ports 20 is not permitted. From this position, if it is desired to open the valve, the actuator member 30 is driven for angular movement. This may be undertaken manually, or may be undertaken in an automated fashion. Where located in a subsea location, it may be achieved through the use of, for example, an appropriately controlled remotely operated vehicle. The rotation or angular movement of the actuator member 30 is transmitted via the drive shaft 28 to the valve member 22. The movement of the valve member 22 drives the gate buttons 26 to positions in which they no longer close the ports 20. Accordingly, fluid is able to flow between the ports 20 via the chamber 16. Fluid is prevented from escaping from the chamber 16 along the bore 14, or such escape is restricted, by the seal arrangement 36.

The fluid pressure within the chamber 16 acting open the valve member 22 may urge the valve member 22 away from the seating surface 18. The presence of the roller bearing arrangement 34 restricts the distance through which the valve member 22 is able to move in this direction and ensures that rotation of the valve member 22 can continue to take place, as required, without requiring the application of excessive torque loadings to the drive shaft 28.

To return the valve to its closed position, the valve member 22 is driven back to the position shown.

Where used in a high pressure environment, then the actuator member 30 may experience high pressures urging the actuator member 30 towards the housing 12. Such loadings may cause the drive shaft 28 and valve member 22 to move towards the seating surface 18. Once the valve member 22 has reached a position in which the stop projection 42 abuts the seating surface 18, further movement of the valve member 22 in this direction is prevented. The telescopic nature of the coupling 38 can accommodate such further movement of the actuator member 30 as may occur, the coupling 38 contracting, as required.

As axial movement of the drive shaft 28 and valve member 22 is restricted by stop projection 42 abutting the seating surface 18, it will be appreciated that the hyperbaric pressure originating loading experienced by the actuator member 30 need not result in the gate buttons 26 being forced against the seating surface 18 with a sufficiently high load that damage to the seating surface 18 and/or the gate buttons 26 may occur. The valve may thus be used for a relatively long period of time without requiring servicing or maintenance operations to be conducted. Furthermore, the torque which is required to drive the valve member 22 for rotation need not be excessively high as resistance to rotation or angular movement of the valve member 22 may be relatively low.

It will be appreciated that as the resistance to rotation or angular movement of the valve member 22 is reduced through the presence of the bearing arrangement 34 and the stop projection 42 in conjunction with the coupling 38, the torque bearing capacity of the drive shaft 28 need not be high. The drive shaft 28 may thus be of reduced diameter without running the risk of increased levels of drive shaft failure.

Turning to FIGS. 2 and 3, an alternative embodiment of the invention is illustrated. The embodiment of FIGS. 2 and 3 is very similar to that of FIG. 1, and operates in substantially the same manner, and only the material differences between the embodiments is set out below.

In the arrangement of FIG. 1, the bearing arrangement 34 takes the form of a roller bearing. This need not always be the case and other forms of bearing arrangement may be used. By way of example, as shown in FIGS. 2 and 3, the bearing arrangement 34 may take the form of a first bearing member 34a of annular, washer-like form located between the face of the valve member 22 facing away from the seating surface 18 and the corresponding wall of the chamber 16. The bearing member 34a is of a low friction material that is of good resistance to wear. By way of example, it may be of PTFE or PEEK. However, other materials may be used.

Additionally, the bearing arrangement 34 comprises a second bearing member 34b or static form, the second bearing member 34b being of cylindrical shape and located between a side of the valve member 22 and the corresponding face of the chamber 16.

It will be appreciated that the first bearing member 34a serves to resist or restrict axial movement of the valve member 22 whilst supporting the valve member 22 for rotation, and that the second bearing member 34b serves to resist or restrict lateral movement of the valve member 22 whilst supporting the valve member 22 for rotation. In both cases, the bearings serve to reduce resistance to rotation arising from the action of fluids under high pressure acting against the valve member 22 urging it for axial and/or lateral movement. As a result, the load that must be applied to the valve member 22 to drive it for rotation may be reduced.

Whilst FIGS. 2 and 3 illustrate the presence of two separate bearing members 34a, 34b, these components could be integrated with one another to form a single bearing member of cup-like or cone-like form, if desired. Furthermore, in some arrangements, one or other of the bearing members 34a, 34b may be omitted.

Although referred to herein as static bearings, to distinguish from roller bearings in which the individual bearing elements rotate about their axes, the bearing members 34a, 34b may move in use. For example, they may rotate with the valve member 22, if desired, may remain stationary, or may move at an intermediate rate or intermittently, if desired.

Whilst specific embodiments of the invention are described herein with reference to the accompanying drawings, a wide range of modifications and alterations may be made to the described and illustrated embodiments without departing from the scope of the invention as defined by the appended claims.

1. A rotary valve comprising a housing defining a chamber, a valve member located within the chamber and engageable with a seating surface to control fluid communication between a first port and a second port, a drive shaft controlling the angular position of the valve member, and an actuator coupled to the drive shaft, wherein a bearing arrangement is provided between a surface of the valve member and a surface of the housing defining the chamber.

2. A valve according to claim 1, wherein the bearing arrangement comprises a roller bearing arrangement.

3. A valve according to claim 1, wherein the bearing arrangement comprise a static bearing member.

4. A valve according to claim 3, wherein the bearing member is of a low friction material with a good wear resistance.

5. A valve according to claim 3, wherein the bearing member is one of PTFE and PEEK.

6. A valve according to claim 1, wherein the bearing arrangement is located between a surface of the valve member opposing the face thereof that, in use, bears against the seating surface and a corresponding surface of the chamber.

7. A valve according to claim 1, wherein the bearing arrangement bears against a side of the valve member.

8. A valve according to claim 3, wherein the bearing arrangement comprises a bearing member of cup shaped or conical form.

9. A valve according to claim 1, wherein the drive shaft is integrally formed with the valve member.

10. A valve according to claim 1, wherein the drive shaft is a separate component coupled to the valve member.

11. A valve according to claim 1, wherein a seal arrangement is provided between the drive shaft and the housing.

12. A valve according to claim 1, wherein the coupling of the actuator to the drive shaft is of a form allowing limited relative axial movement therebetween.

13. A valve according to claim 12, wherein the coupling between the actuator and the drive shaft is of limited telescoping form.

14. A valve according to claim 13, wherein the drive shaft includes an end part of non-circular cross-sectional shape received within a recess of a similar non-circular cross-sectional shape provided in the actuator such that relative angular movement between the actuator and the drive shaft is restricted, whilst relative axial movement therebetween is permitted.

15. A valve according to claim 14, wherein the cross-sectional shapes of the interengaging parts of the drive shaft and the actuator are chosen to allow the actuator to be fitted to the drive shaft in a single relative angular orientation

16. A valve according to claim 1, wherein the valve member is provided with a stop projection engageable with the seating surface to restrict movement of the valve member relative to the seating surface.

17. A valve according to claim 16, wherein the valve member is arranged to carry at least one gate button engageable with the seating surface, the gate button being moveable relative to the valve member through a first distance, the maximum spacing of the stop projection from the seating surface being smaller than the first distance.

18. A rotary valve comprising a housing defining a chamber, a valve member located within the chamber and engageable with a seating surface to control fluid communication between a first port and a second port, a drive shaft controlling the angular position of the valve member, and an actuator coupled to the drive shaft, wherein the coupling of the actuator to the drive shaft is of a form allowing limited relative axial movement therebetween.

19. A valve according to claim 18, wherein the coupling between the actuator and the drive shaft is of limited telescoping form.

20-23. (canceled)

24. A rotary valve comprising a housing defining a chamber, a valve member located within the chamber and carrying at least one gate button engageable with a seating surface to control fluid communication between a first port and a second port, a drive shaft controlling the angular position of the valve member, and an actuator coupled to the drive shaft, wherein the valve member or drive shaft is provided with a stop projection engageable with the seating surface to restrict movement of the valve member relative to the seating surface.

25. (canceled)
